(19) United States
(12) Patent Application Publication
(10) Pub. No.: US 2006/0130684 A1
(43) Pub. Date: Jun. 22, 2006

(54) Web-fed rotary press

(76) Inventor: Robert Weiss, Gersthofen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/287,533

(22) Filed: Nov. 23, 2005

(30) Foreign Application Priority Data
Nov. 25, 2004 (DE) 10 2004 056 931.2

(51) Int. Cl. B41F 13/24

(52) U.S. Cl. 101/247

(57) ABSTRACT

In a web-fed rotary press having printing units arranged in two rows, a more universal use is achieved in that each row of printing units is assigned at least one transfer system, such as a transfer cylinder or a web contact pressure cylinder or a transfer and web guidance unit, and the transfer systems are arranged at a distance from each other on the mutually facing sides of the rows of printing units.

This application claims the priority of German Patent Document No. 10 2004 056 931.2, filed Nov. 25, 2004, the disclosure of which is expressly incorporated by reference herein.

### BACKGROUND AND SUMMARY OF THE INVENTION

The invention relates to a web-fed rotary press having printing units arranged in two rows.

In a known press of this generic type which is provided for offset printing, the printing material web is printed on both sides between the transfer cylinders of the printing units of the two rows. If only single-sided printing is to be carried out with this press, which occurs for example when printing packages, only half its capacity is used, since the transfer cylinders of the non-printing row of printing units must continue to run as back-pressure cylinders.

The invention is based on the object of developing a web-fed rotary press of the generic type mentioned at the beginning such that different production paths can be run and therefore more universal possibilities for use are achieved.

According to the invention, this is achieved in that each row of printing units is assigned at least one web contact pressure cylinder and the web contact pressure cylinders are arranged at a distance from each other on the mutually facing sides of the rows of printing units.

When this configuration is used, the possibilities are provided of printing a printing material web on one side in each case with each of the rows of printing units, of printing a web on one side with all the printing units present or of printing a printing material web on the front side with the printing units of one row and on the reverse side with the printing units of the other row.

### BRIEF DESCRIPTION OF THE DRAWINGS

Further features and advantages emerge from the description of some exemplary embodiments of the invention by using the drawings.

FIG. 1 shows the structure according to the invention of a press for indirect printing.

FIGS. 2-5 show different types of production of the press according to FIG. 1.

FIG. 6 shows the structure according to the invention of a press for direct printing.

FIGS. 7-10 show different types of production of the press according to FIG. 6.

FIGS. 11 and 12 show variants of the press for indirect printing when transfer belts are used.

FIGS. 13-15 show different types of production for indirect printing when transfer belts are used.

FIG. 16 shows a variant of a press for direct printing when transfer belts are used.

### DETAILED DESCRIPTION OF THE DRAWINGS

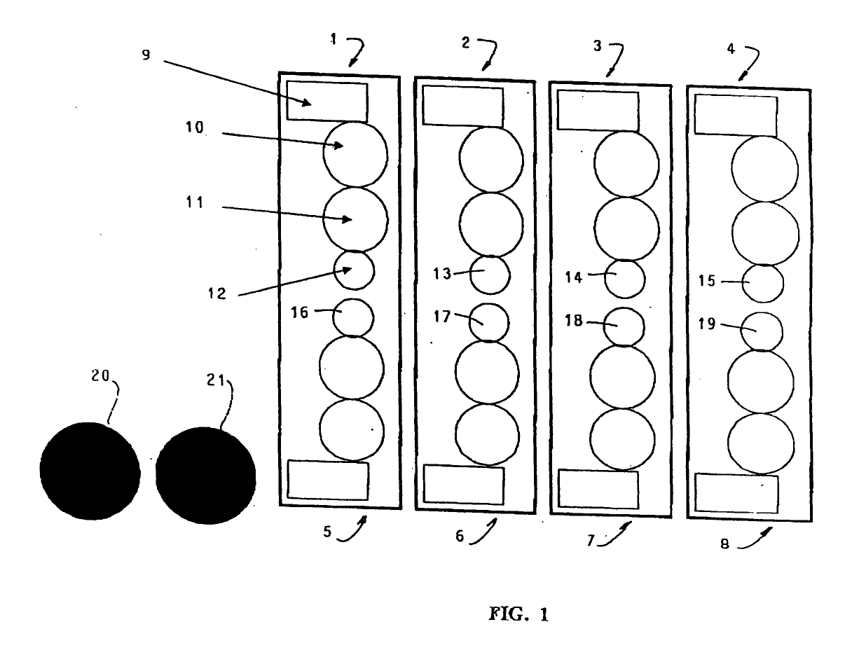

The press according to FIGS. 1-5 has an upper row of four printing units 1-4 and a lower row of four printing units 5-8. The printing units are expediently but not necessarily arranged horizontally. Furthermore, the invention is not restricted to presses having eight printing units but can also be used in presses having a different number of printing units. The printing unit 1 comprises an inking apparatus 9, a printing form cylinder 10 and a transfer element 11 which, in the exemplary embodiment, is constructed as a transfer cylinder. The other printing units are constructed in the same way. Each of the printing units 1-8 is assigned a transfer system, such as a transfer cylinder/transfer unit or a web contact pressure cylinder 12-19. The web contact pressure cylinders 12-15 and 16-19 are arranged on the mutually facing sides of the printing units 1-4 and 5-8. Between two mutually opposite web contact pressure rolls, for example 12 and 16, in each case, a space is provided such that they do not touch in any position.

In an offset press, the inking apparatus can comprise an inking and damping unit. In other types of printing, it comprises only an imaging and/or developing unit. The printing form cylinder in an offset press can be constructed as a plate cylinder with interchangeable or reusable plates or sleeves or as a surface which can be imaged directly. In other printing processes, it can be constructed, for example, as a gravure printing form cylinder or flexographic printing cylinder or photoconductor cylinder. Connected upstream of the press are two carriers 20, 21, each for a supply roll of printing material web.

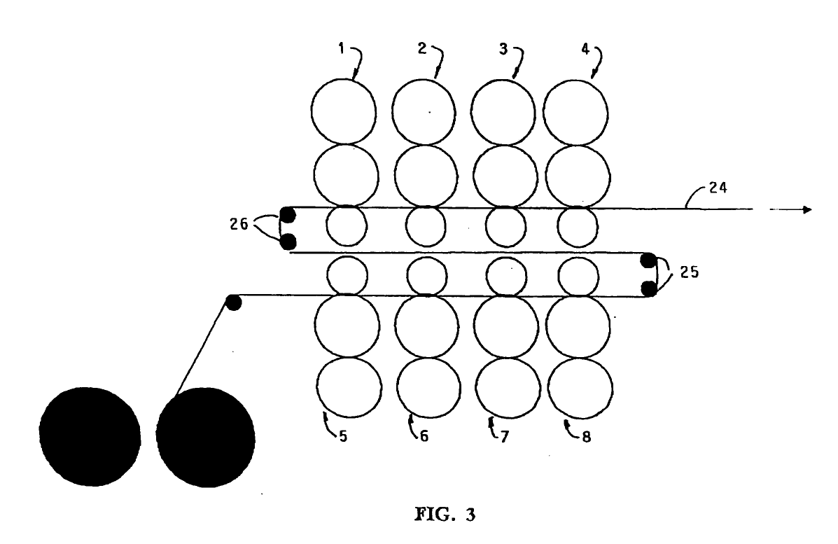

The printing units 1-4 together with the transfer system, such as transfer cylinders or web contact pressure cylinders 12-15, on one hand, and the printing units 5-8 together with the transfer systems, such as transfer cylinders or web contact pressure cylinders 16-19, can each have a common drive. However, there is also the possibility of driving the transfer systems, such as transfer cylinders or web contact pressure cylinders, the transfer elements, the printing form cylinders and the inking apparatuses each on their own or of providing a group drive for two or more elements. In the case in which individual drives or group drives are used, it must be possible for the drives to be synchronized for all the printing units in relation to the variants according to FIGS. 3-5.

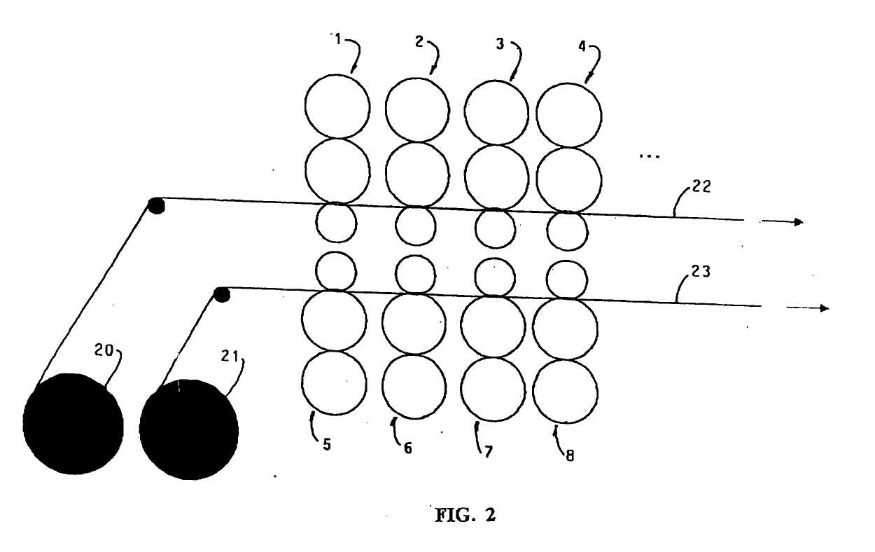

As FIG. 2 shows, a printing material web 22 can be printed by using the printing units 1-4 and a further printing material web 23 can be printed by using the printing units 5-8, in each case on one side. Furthermore, this web guidance path permits the printing material web 22 to be printed, for example with the printing units 1-4, and at the same time permits the printing units 5-8 to be changed over.

Different web guidance is shown by FIG. 3, in which one printing material web 24 is led through the press. The printing material web 24 is firstly printed on one side with the printing units 5-8. The printing material web is then lead over deflection rollers 25, 26 in such a way that the other side of the printing material web 24 is likewise printed.

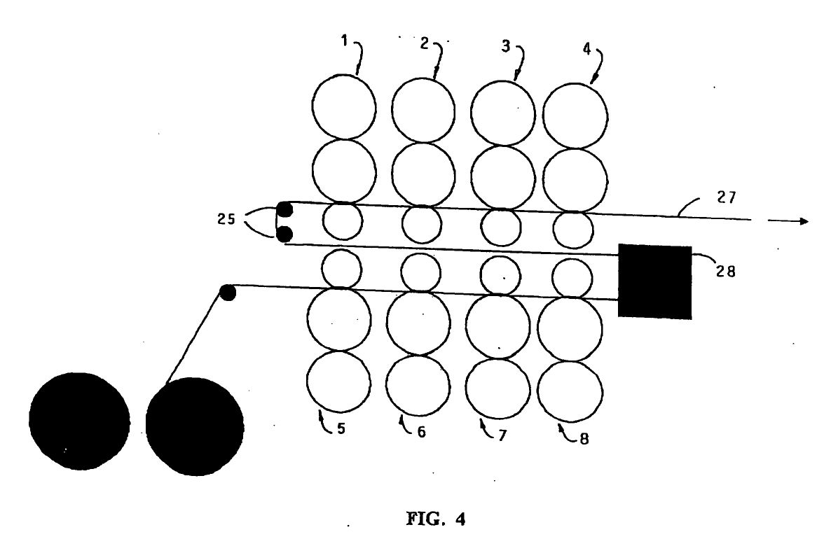

Another possibility is shown by FIG. 4. In this configuration, first of all a printing material web 27 is printed on one side by means of the printing units 5-8. The printing material web 27 then runs through a turner unit 28 and over deflection rollers 25 to the printing units 1-4, which print other colors on the already printed side of the printing material web 27.

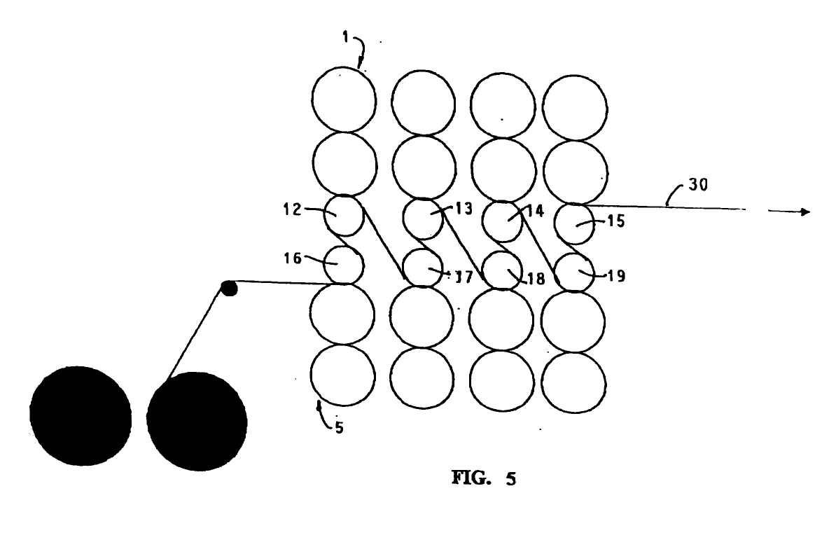

Another variant of the two-sided printing is shown by FIG. 5. In this arrangement, a printing material web 30 firstly runs around the web contact pressure cylinder 16 of the printing unit 5 and receives a print on one side. The printing material web 30 is then led around the web contact pressure cylinder 12 of the printing unit 1 and here receives a print on the reverse side. From here, the printing material web 30 runs to the web contact pressure cylinder 17 and then over the web contact pressure cylinder 17 back to the web contact pressure cylinder 13 and from here over the web contact pressure cylinder 14 to the web contact pressure cylinders 19 and 15. Therefore, in the case of this web guidance, the printing material web 30 is in each case led around the web contact pressure cylinder of the one printing unit to the web contact pressure cylinder of the opposite printing unit and then to the web contact pressure cylinder located obliquely opposite. This likewise results in a print on both sides of the printing material web 30. As compared with the arrangement according to FIG. 3, the deflection rollers 25, 26 can be omitted here.

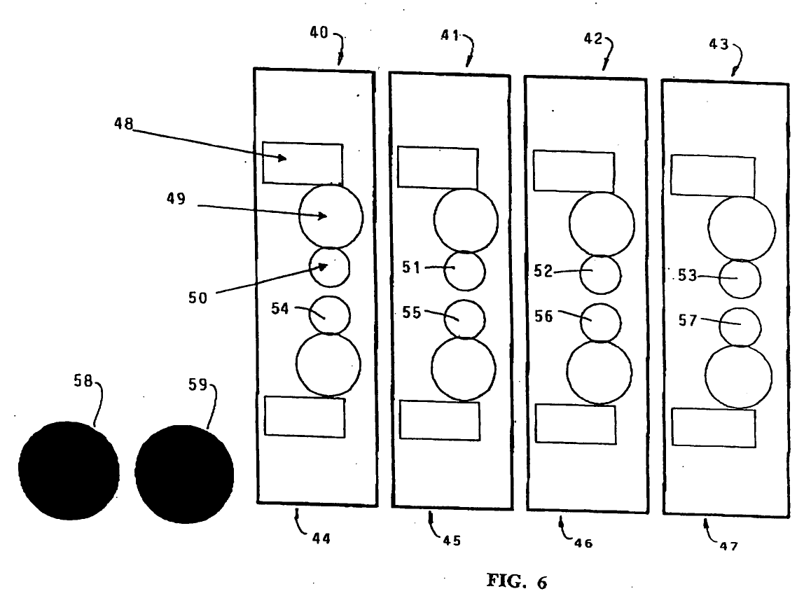

FIG. 6 shows the application of the invention in a press for direct printing. In this machine, once again a first row of printing units 40-43 and a second row of printing units 44-47 are provided. Each printing unit, for example 40, has an inking apparatus or imaging and developing unit 48 and a printing image carrier 49. The printing image carrier, for example 49, of each printing unit 40-47 is in each case assigned a transfer system, such as transfer cylinders or web contact pressure cylinders 50-57. Arranged upstream of the printing units 40-47 are two carriers 58, 59, each for a supply roll of printing material web.

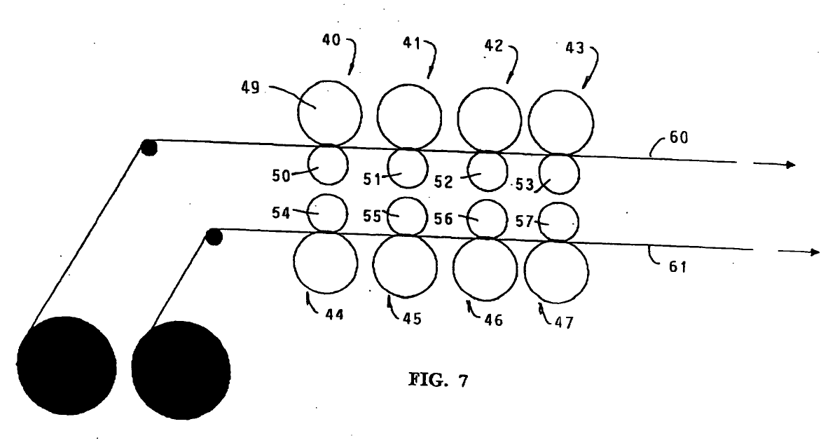

As FIG. 7 indicates schematically, by using this press, a first printing material web 60 can be printed between the transfer systems, such as transfer cylinder or web contact pressure cylinders 50-53, and the printing image carriers, for example 49, of the upper row of printing units 40-43, and a second printing material web 61 can be printed between the transfer systems, such as transfer cylinder or web contact pressure cylinders 54-57, and the printing image carriers of the lower row of printing units 44-47, in each case on one side. Since the two rows of printing units are driven independently of each other, there is also the possibility here, for example, of carrying out printing with the upper printing units 40-43 and changing over the lower printing units 44-47.

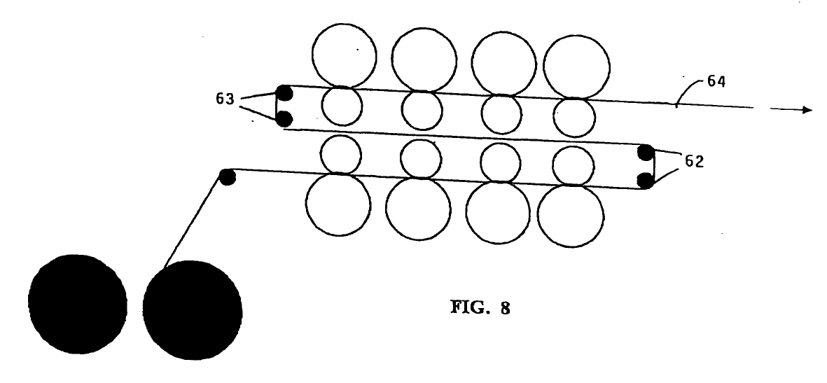

As FIG. 8 shows, as a result of arranging deflection rolls 62, 63, there is the possibility of printing a printing material web 64 on both sides in all the printing units.

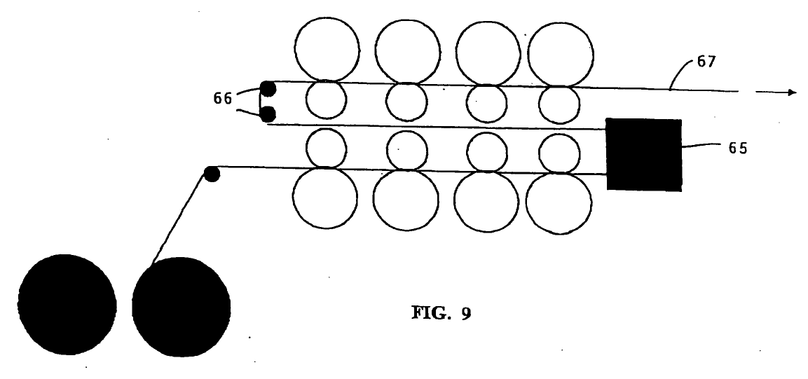

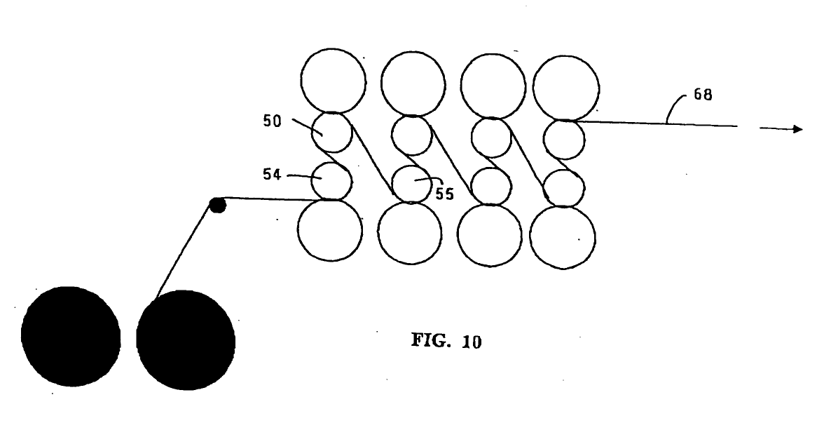

In a manner analogous to the first exemplary embodiment, as FIG. 9 shows, by arranging a turner unit 65 and deflection rolls 66, a printing material web 67 can be printed on one side with as many colors as printing units are provided. As an alternative to the arrangement according to FIG. 8, in a manner analogous to the arrangement according to FIG. 5, there is also the possibility of printing a printing material web 68 on both sides with the omission of the deflection rollers 62, 63. To this end, as FIG. 10 shows, the printing material web 68 is led from the transfer system, such as transfer cylinder or contact pressure cylinder 54, to the transfer system, such as transfer cylinder or web contact pressure cylinder 50, and from the latter to the transfer system, such as transfer cylinder or web contact pressure cylinder 55, and then in the same way through the press.

The invention is also suitable for electrographic printing processes, such as electrophotography. In this case, instead of the inking apparatus 48, a charging, imaging and developing apparatus must be provided, which outputs the image generated to a printing image carrier 49 constructed as a photoconductor. The remainder of the construction of the printing units is unchanged as compared with the exemplary embodiment according to FIG. 6.

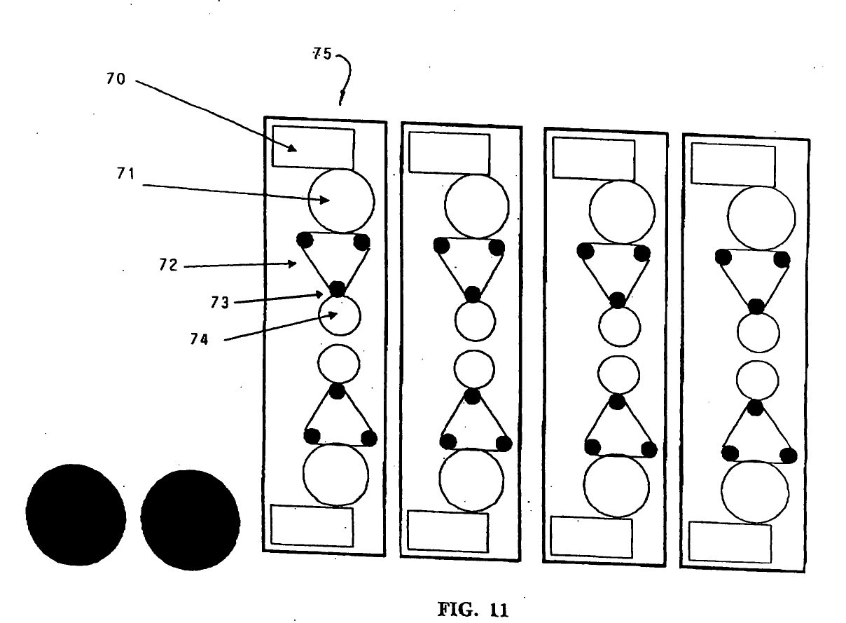

A variant of the exemplary embodiment according to FIG. 1 is illustrated in FIG. 11 using the example of a press with image generation by means of electrophotography, without being restricted to this. Here, each printing unit 75 has a charging, imaging and developing device 70, which generates the printing image on a printing image carrier 71 constructed as a photoconductor cylinder. The printing image is then passed on via transfer element 72 constructed as an endless belt. The transfer element 72 is preferably constructed in such a way that one of the deflection rolls 73 is opposite the web contact pressure cylinder 74. Of course, variants of transfer elements constructed in different ways by using endless belts are conceivable. All the other printing units are constructed in the same way. This press permits the same web guidance paths as illustrated in FIGS. 2-5.

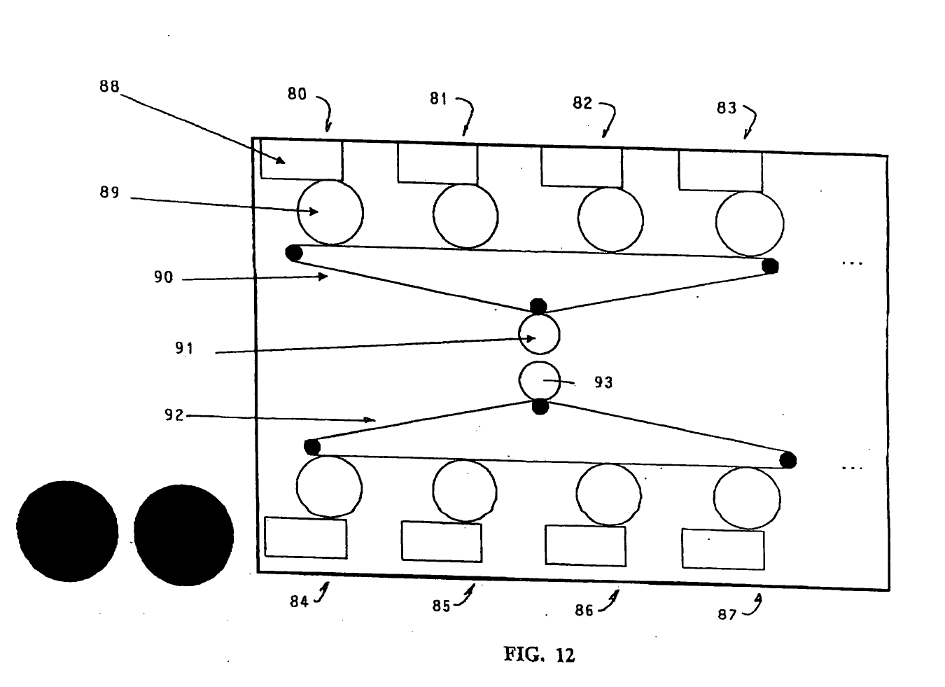

A further configuration according to the invention is illustrated in FIG. 12, using the example of a press having electrographic image generation. Here, once more a first row of printing units 80-83 and a second row of printing units 84-87 are provided. Each printing unit has a charging, imaging and developing device 88 and a cylindrical printing image carrier 89, for example constructed as a photoconductor. The printing image carriers of the printing units 80-83 output their printing image to a common transfer element 90 constructed as an endless belt. The transfer element 90 is assigned a transfer system in the form of a transfer and web guidance unit 91. In the same way, the printing units 84-87 output their printing images to a transfer element 92 constructed as a belt, which interacts with a further transfer and web guidance unit 93.

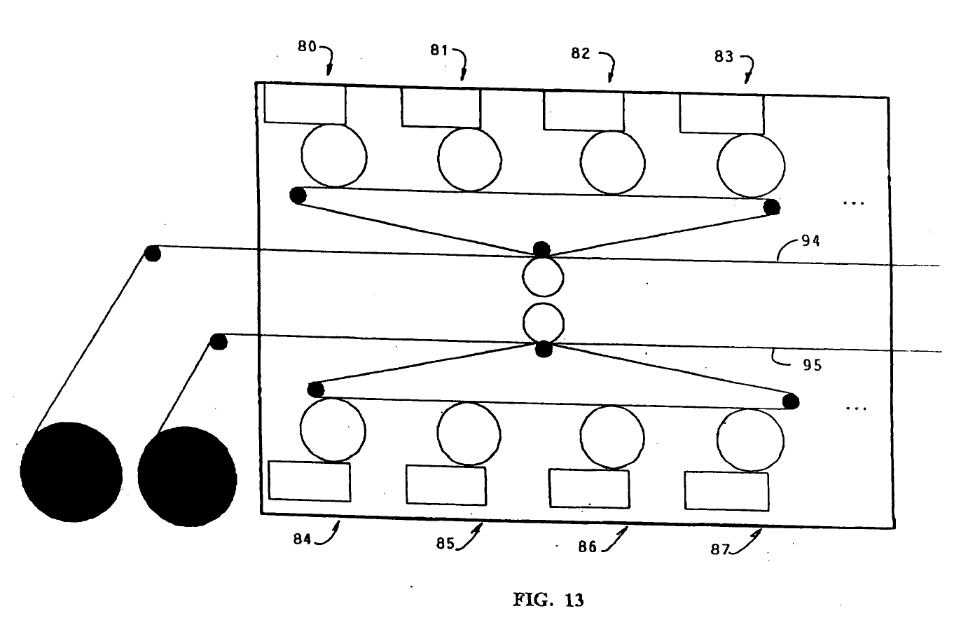

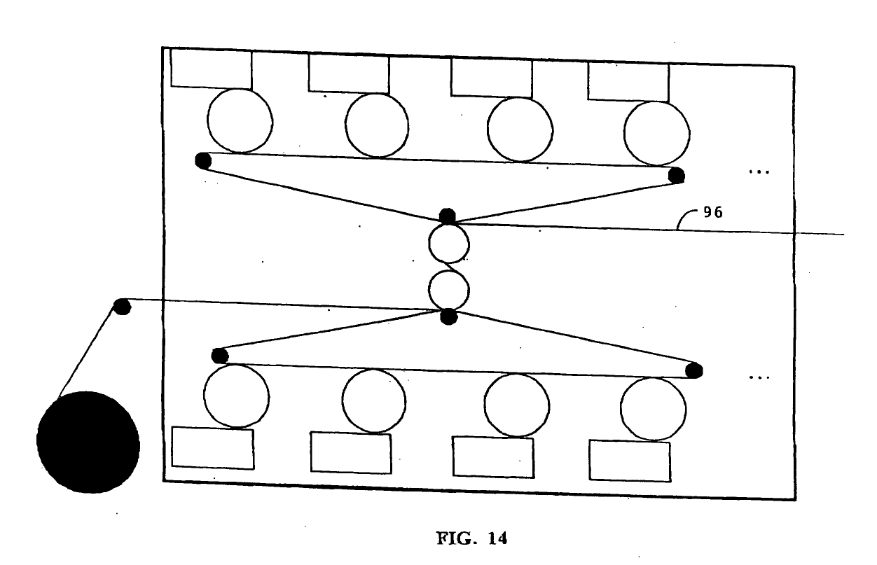

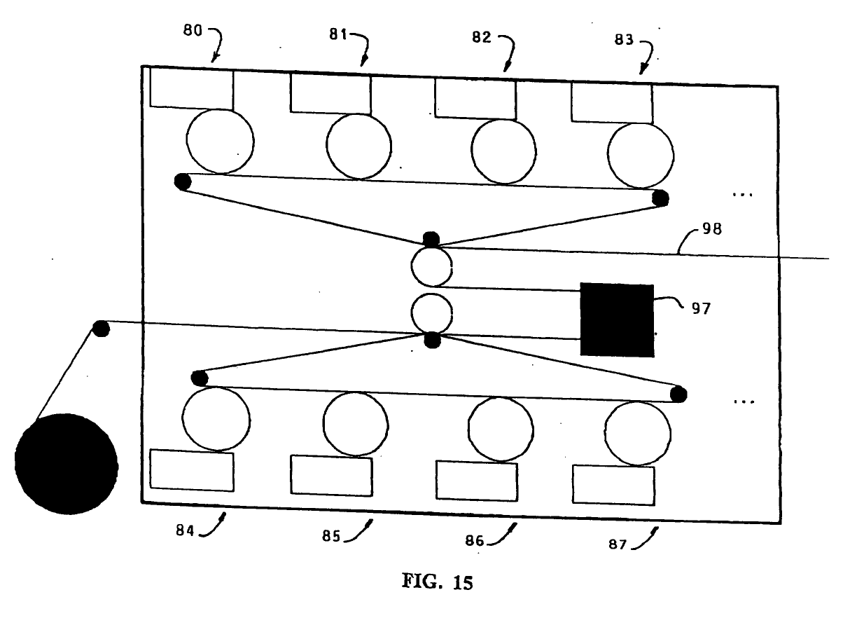

As FIG. 13 shows, once again two paper webs 94, 95 can be printed independently of each other with this press, on one side in each case. There is also the possibility of printing only with the printing units 80-83 and making a change to the printing material in the printing units 84-87 for example. FIG. 14 shows the guidance of a printing material web 96 which is printed on both sides. Finally, as FIG. 15 reveals, by arranging a turner unit 97, there is provided printing of a printing material web 98 on one side with all the printing units 80-87.

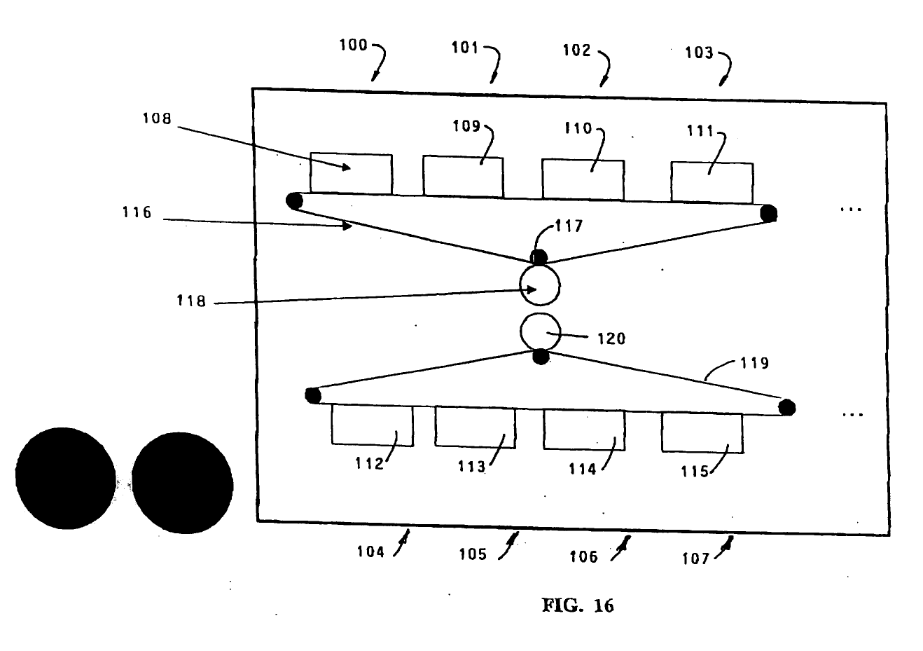

The press according to FIG. 16, provided for direct printing with an electrographically generated printing image, again has a first row of printing units 100-103 and a second row of printing units 104-107. Each printing unit comprises a (charging), imaging and developing unit 108-115. The (charging), imaging and developing units of the first row of printing units 100-103 generate an image on a common printing image carrier 116 in the form of an endless belt which, here, as an example, is constructed as a collecting photoconductor belt. In this case, a deflection roller 117 of the printing image carrier 116 is located opposite a transfer system, such as a transfer cylinder or a web contact pressure cylinder 118. The printing units 104-107 are constructed in the same way. Their printing image carrier 119 interacts with a transfer system, such as a transfer cylinder or web contact pressure cylinders 120. By using this arrangement, the same web guidance paths can be implemented as illustrated in FIGS. 7-10.

As the above exemplary embodiments show, by using simple means, a printing system can be created from an in-line press for recto and verso printing which permits a plurality of web guidance paths which lead to different printed results.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A web-fed rotary press having two printing units arranged in two rows, wherein each row of printing units is assigned at least one transfer system, such as a transfer cylinder or a web contact pressure cylinder or a transfer and web guidance unit, and wherein the transfer systems are arranged at a distance from each other on a mutually facing side of the rows of printing units.

2. The web-fed rotary press according to claim 1, wherein the press is an indirect printing press and wherein the transfer cylinder is arranged downstream of an element carrying a printing image.

3. The web-fed rotary press according to claim 1, wherein the press is an indirect printing press and wherein at least one endless transfer belt is connected downstream of an element carrying a printing image.

4. The web-fed rotary press according to claim 3, wherein a transfer belt is connected downstream of the element carrying the printing image.

5. The web-fed rotary press according to claim 3, wherein a common transfer belt is connected downstream of a plurality of elements carrying the printing image.

6. The web-fed rotary press according to claim 1, wherein the press is a direct printing press and wherein an element carrying a printing image interacts with a respective transfer system.

7. The web-fed rotary press according to claim 2, wherein the element carrying the printing image is a press cylinder.

8. The web-fed rotary press according to claim 3, wherein the element carrying the printing image is a press cylinder.

9. The web-fed rotary press according to claim 6, wherein the element carrying the printing image is a press cylinder.

10. The web-fed rotary press according to claim 1, wherein for electrophotographic or magnetographic or ionographic printing processes, an element carrying a printing image is a photoconductor cylinder or a magnetizable cylinder or a dielectric cylinder.

11. The web-fed rotary press according to claim 1, wherein for electrophotographic or magnetographic or ionographic printing processes, an element carrying a printing image is an endless belt.

12. The web-fed rotary press according to claim 1, wherein a transfer or photoconductor belt is led over deflection rollers and one of the deflection rollers is arranged opposite the transfer system.

13. The web-fed rotary press according to claim 1, wherein each row of printing units is assigned a carrier for a supply roll of printing material web.

14. The web-fed rotary press according to claim 1, wherein deflection rollers are arranged in a web run between one row of printing units and the other row of printing units.

15. The web-fed rotary press according to claim 1, wherein a web turner device is arranged between one row of printing units and the other row of printing units.

16. The web-fed rotary press according to claim 1, wherein one row of printing units is drivable independently of the other row of printing units.

17. A web-fed rotary press, comprising:
a first printing unit;
a second printing unit;
a first transfer system associated with the first printing unit and included on a side of the first printing unit that faces the second printing unit; and
a second transfer system associated with the second printing unit and included on a side of the second printing unit that faces the first printing unit;
wherein the first and second transfer systems are arranged at a distance from each other.

18. The web-fed rotary press according to claim 17, wherein the first printing unit is arranged in a first row of printing units, wherein the second printing unit is arranged in a second row of printing units, and wherein the first row is oriented opposite the second row.
